(19) United States
(12) Patent Application Publication
(10) Pub. No.: US 2016/0039614 A1
(43) Pub. Date: Feb. 11, 2016

(54) OSCILLATING CONVEYOR FOR 2-DIMENSIONAL MOVEMENT OF OBJECTS AND METHOD FOR OPERATION OF THE OSCILLATING CONVEYOR

(71) Applicant: Afag Holding AG, Hergiswil (CH)

(72) Inventors: Klaus BOTT, Altdorf (DE); Izudin MESAN, Nurnberg (DE); Sebastian MOJRZISCH, Hannover (DE); Jens TWIEFEL, Hannover (DE); Jörg WALLASCHECK, Hannover (DE)

(21) Appl. No.: 14/817,419

(22) Filed: Aug. 4, 2015

(30) Foreign Application Priority Data
Aug. 6, 2014 (DE) 10 2014 111 168.0

(51) Int. Cl. B65G 27/32; G05D 19/02

(52) U.S. Cl. CPC B65G 27/32; G05D 19/02

(57) ABSTRACT

An oscillating conveyor for the two-dimensional movement of objects, comprising an oscillating plate, on the conveying surface of which at least one object is movable by the oscillations of the oscillating plate, and at least two excitation elements for exciting oscillations in the oscillating plate, wherein the excitation elements are ultrasound transducers coupled to the oscillating plate at excitation positions spaced a certain distance apart, by means of which transducers the oscillating plate can be excited to oscillate at the excitation position in question as a function of a control signal, which can be sent individually by a control unit to each excitation element.

### CROSS-REFERENCE TO RELATED APPLICATIONS

The present application claims priority of 10 2014 111 168.0, filed Aug. 6, 2014, the priority of this application is hereby claimed and this application is incorporated herein by reference.

### BACKGROUND OF THE INVENTION

The invention pertains to an oscillating conveyor for the two-dimensional movement of objects, comprising an oscillating plate, on the conveying surface of which at least one object can be moved by the oscillations of the oscillating plate, and at least two excitation elements for exciting oscillations of the oscillating plate.

Oscillating conveyors are used to convey a large variety of objects, especially relatively small ones. The objects are conveyed by vibrations. Typically, rigid conveyor rails or rigid plates are used, which perform an elliptical movement and thus transport the objects by means of “micro-tosses”.

During the transport or movement of objects such as electrical components, for example, it is desirable to be able to move the objects two-dimensionally, to be able to orient the objects, and/or to be able to separate accumulations of objects. An alignment and separation of objects can be accomplished with an oscillating conveyor in that, for example, during a longitudinal conveying process on an oscillating conveyor, the conveying surface of the conveyor is profiled in the conveying direction, so that individual objects are guided and aligned in the individual profiles. As an alternative, it is known that an oscillating plate can be configured to be movable in all three spatial dimensions by means of separate actuators. As a result, several objects can be shifted simultaneously in two different directions on an oscillating plate.

So that individual objects can be moved separately, DE 102 61 659 A1 proposes that a plurality of actuators be provided on the surface of a plate, which can be excited to oscillate in several spatial directions; each of these actuators exerts a normal force on the objects during a previously determined activation time. Thus, although it is true that objects can be moved individually and in the desired direction, it is nevertheless technically very complicated to implement an arrangement such as this for moving objects, and it is never possible to move such objects separately unless the actuators provided can exert a force on them, e.g., by magnetic objects.

### SUMMARY OF THE INVENTION

The invention is therefore based on the goal of providing an oscillating conveyor which can be realized relatively easily in technical terms and which nevertheless makes it possible to control the direction in which the objects move and/or to separate objects lying close together on the conveying surface.

The goal is achieved according to the invention by an oscillating conveyor of the type described above, wherein the excitation elements are ultrasound transducers connected to the oscillating plate at excitation positions a certain distance apart, by means of which transducers the oscillating plate can be excited to oscillate at the excitation position in question as a function of a control signal, which can be sent individually by a control unit to each excitation element.

According to the invention, it is proposed that ultrasound transducers connected to the oscillating plate at excitation positions a certain distance apart be used to excite the oscillating plate to oscillate. Because of the high excitation frequency and the local coupling-in of the excitation, the oscillating plate does not execute an overall oscillation, in which the entire oscillating plate oscillates as a stiff element; on the contrary, what is excited are preferably bending oscillations, especially surface oscillations of the conveying surface of the oscillating plate. As a result of this excitation, traveling waves and/or standing waves are formed on the conveying surface, which cause the objects to move.

As the amplitude of a traveling wave decreases with increasing distance from the source, i.e., in particular from one of the excitation positions, objects are transported on the conveying surface in the direction opposite the direction in which the traveling wave propagates. When a standing wave is created on the oscillating plate, objects are moved toward the nodes of the standing wave. By means of appropriate control signals provided by the control unit, the ultrasound transducers can be actuated independently of each other, wherein preferably the same oscillation frequency is used for all of the ultrasound transducers. Thus various overall oscillations of the oscillating plate can be achieved. Through variation of the control signals, especially through variation of the amplitude ratios and/or the phases of the control signals sent to the excitation elements, objects on the conveying surface can be moved in various directions. For a large number of combinations of control signals, furthermore, the direction in which an object moves depends on the position of that object on the conveying surface. Even a small difference in this position can lead to a pronounced difference in the direction of movement. Thus the oscillating conveyor according to the invention is adapted to position an object on the oscillating plate by means of movement in various directions and also to singulate objects, that is, to move objects lying close together in different directions.

The control unit can comprises several control circuits, each of which is assigned to one or more of the excitation elements. It is possible for the control circuits to control individual excitation elements or groups of excitation elements completely independently of each other. It is advantageous, however, for the control circuits to be synchronized, so that control signals with the same oscillation frequency and in particular with the same, previously determined phase position for all of the various control signals can be provided.

In the oscillating conveyor according to the invention, it is possible to send a control signal to only one of the excitation elements and to connect the other excitation elements to ground potential, for example. Especially when an oscillating plate with a damping function or additional oscillation-damping elements are used, a traveling wave is generated on the oscillating plate which proceeds from the excitation position of the actuated excitation element and loses amplitude with increasing distance from this excitation position. A traveling wave of this type causes objects on the oscillating plate to move toward the excitation position in question, wherein the speed of this movement increases with increasing proximity to the excitation position. In an oscillating conveyor according to the invention, several excitation elements are used, which in particular do not lie on a straight line. An object can already be moved in a plurality of different directions simply as a function of the choice of the excitation element to be actuated. As a result of the position-dependent speed of the movement, it is also possible to singulate objects even by the actuation of only a single excitation element.

It is desirable, however, for it to be possible to move objects along curved paths on the oscillating plate without any change in the actuation of the excitation elements and/or to produce various directions of movement even when only a few, in particular only two, excitation elements are used.

It is therefore possible for the excitation elements to be actuatable by the control unit in such a way that, by a superimposition of the excited oscillations, the conveying surface can be made to execute an overall oscillation. Control signals which lead to the oscillation of an excitation element are therefore sent to several excitation elements. How objects can be moved by the use of an overall oscillation formed by the superimposition of excited oscillations is explained by way of example below on the basis of the actuation of two excitation elements. Obviously, more than two excitation elements can be actuated simultaneously to generate oscillations for the purpose of producing an overall oscillation. In addition, it is assumed in the following that the two excitation elements are excited at the same frequency. Excitation with different frequencies at different positions is also possible, but the effects are more difficult to grasp intuitively.

In a simple example, several objects are arranged on a line connecting the excitation positions of the two excited excitation elements. If the amplitudes of the excited oscillations are the same, i.e., if the control signals in particular have the same amplitude and if the excitation elements have the same configuration, each of the objects is moved toward the excitation position to which it is closer at the start of the excitation. If, at the beginning therefore, the objects are, for example, distributed uniformly in the area between the excitation positions, they will be divided into two groups. By adapting the relative amplitudes of the control signals, the point between the excitation positions at which the direction in which the objects move changes can be adjusted.

In a second example, an object will be considered which is located in an object position on the conveying surface which is a certain distance away from the straight line connecting the excitation positions of the actuated excitation elements. First, it will be assumed that the oscillation amplitudes of the two excitation elements and the distance of each of the objects from the excitation positions are the same. In this case, the object moves toward the connecting line in a direction which is perpendicular to the direction of the connecting line. The object thus moves closer to both excitation elements. If, at the beginning, the object is closer to one of the two excitation positions and/or if the amplitude of one of the control signals is greater than the amplitude of the other control signal, then the object will approach one of the excitation positions faster than it does the other. What happens in this case is that the object moves along a curved path.

By means of an appropriate choice of the amplitudes of the control signals, it is possible to determine the angle between the direction of movement and the straight connecting line for an object in a certain object position which is not on the straight connecting line between the two actuated excitation elements. An appropriate choice of the amplitudes allows a free determination of any angle between a linear movement toward the first of the excitation areas and a linear movement toward the second of the excitation areas. The selectable range of angles can also be expanded by operating one of the excitation elements as a damping element, i.e., by adapting the phase position of the two excitations relative to each other.

It is advantageous for the oscillating conveyor according to the invention to comprise at least three excitation elements, wherein the excitation position of the third excitation element is a certain distance away from the line connecting the excitation positions of the first and second excitation elements. The oscillating conveyor can thus comprise at least three excitation elements which are not on a common straight line. In the oscillating conveyor according to the invention, traveling waves generated by the excitation elements have an attractive effect. By providing at least three excitation elements, a polygon is formed, the vertices of which are formed by the excitation positions. Inside the polygon, an object can be moved to any desired position by specifying appropriate control signals. As many excitation elements as desired can be provided. In addition, additional excitation positions can be provided on connecting lines between the vertices.

The oscillating plate can be polygonal, especially quadrilateral, with several sides, wherein at least one of the excitation elements is arranged at or near the edge of each side. The excitation positions can be arranged within the plate surface of the oscillating plate, and in particular they can be adjacent to the edge of the oscillating plate. Especially when several excitation elements are provided on each side, movement in essentially any direction and at any time can be determined essentially freely for an object on the oscillating plate by adapting the control signals for the excitation elements.

Alternatively, it is possible for the oscillating plate to be essentially round or elliptical, wherein the excitation elements are arranged at the edge, around the periphery.

In both of the cases described above, excitation elements can be arranged alternatively only on some of the sides or only on one section of the periphery.

Each of the ultrasound transducers can comprise a multilayer piezoelectric actuator, especially a prestressed one. Multilayer piezoelectric actuators are especially adapted to producing long strokes and/or strong forces even at relatively low voltages. By prestressing the piezoelectric actuator, i.e., by arranging the layers of the piezoelectric actuator in a housing in such a way that the piezoelectric actuator is already compressed before any voltage is applied, the forces available even at low voltages are increased even more. The housing can be made of ceramic material or of metal, for example.

Each of the piezoelectric actuators can be arranged between the oscillating plate and a counterweight. The counterweight can be connected to the oscillating plate exclusively by the piezoelectric actuator or by the housing of the prestressed piezoelectric actuator and otherwise oscillate freely. Especially during operation of the piezoelectric actuator at a resonance frequency of the system consisting of the piezoelectric actuator, the counterweight, and in particular a coupling element, which connects the piezoelectric actuator to the oscillating plate, it is possible to achieve large oscillating amplitudes even with a control signal of small amplitude.

Each piezoelectric actuator or a coupling element permanently connected to the piezoelectric actuator can be adhered and/or screwed and/or positively fitted to the oscillating plate. Alternatively, a frictional connection between the piezoelectric actuator or the coupling element and the oscillating plate would be possible. The oscillating plate could, for example, be clamped by a clamping device arranged on the coupling element. A stable coupling of the piezoelectric actuator to the oscillating plate is essential for the purpose of achieving optimal introduction of the oscillation into the oscillating plate.

The oscillating conveyor according to the invention can comprise at least one damping element, and/or the oscillating plate itself can be made of an oscillation-damping material, so that the oscillation amplitude of the oscillating plate, when excited by at least one of the excitation elements, decreases in at least one direction along the conveying surface with increasing distance from the excitation position assigned to the excitation element. In particular, a material with high internal friction such as a plastic or an elastomer, for example, can be used as the oscillation-damping material.

The damping element can be arranged on one lateral surface and/or on the conveying surface near the edge and/or on the surface of the oscillating plate facing away from the conveying surface, near the edge. In particular, a flat area of the lateral surface, of the conveying surface, or of the opposite surface can be coated with an oscillation-damping material, or a layer of oscillation-damping material can be applied to the appropriate surface and bonded to it by means of an adhesive, for example.

Alternatively or in addition, it is possible to provide, as the damping element, a damping element which is in frictional contact with the edge of the oscillating plate. In this case, the friction withdraws energy from the oscillating plate, and the oscillation is thus also damped.

By damping the oscillation of the oscillating plate at the edges, the result is achieved that the amplitude of a traveling wave generated by an excitation element decreases with increasing distance from the corresponding excitation position; in addition, reflections from the edges of the oscillating plate and therefore the formation of standing waves are at least partially suppressed.

The damping element can in particular be a flat layer of an oscillation-damping material such as a rubber or an elastomer.

Alternatively or in addition, it is also possible for one or more of the excitation elements of an oscillating conveyor according to the invention to be actuated in such a way as to act as damping elements. At least one selected excitation element can be actuated by the control unit in such a way that it reduces the oscillation amplitude of an oscillation of the oscillating plate generated by one of the other excitation elements, this reduction occurring at the excitation position assigned to the selected excitation element.

For this purpose, the control unit can be configured to actuate the selected excitation element by means of a control signal which is phase-locked in a previously determined phase position to the control signal of the other excitation element. The propagation rate of bending or of surface waves of the oscillating plate is essentially constant. Thus the oscillation amplitude, phase, and frequency at the excitation position of the selected excitation element follow uniquely from the excitation at a specific frequency, amplitude, and phase at the excitation position of the other excitation element. The phase position of the oscillations at the various excitation positions depends exclusively on the oscillation frequency and the propagation rate of the wave on the oscillating plate. By specifying a suitable phase offset between the control signal for the other excitation element and the control signal for the selected excitation element, it is therefore possible for the selected excitation element to be excited to perform an oscillation which is phase-shifted by 180° versus the wave arriving from the other excitation element and thus completely or partially to cancel that wave out.

The same is true when an excitation of the oscillating plate is carried out by means of several additional excitation elements at the same frequency. In particular, when the oscillating plate is excited sinusoidally at several other excitation positions, the addition of the sine-wave signals which have been phase-shifted as a result of their travel times again leads to a sinusoidal oscillation of the same frequency at the excitation position of the selected excitation element. The phase position of this oscillation can be determined from the distances between the other excitation positions and the selected excitation position and by the frequency and the propagation rate of the oscillation on the oscillating plate.

Alternatively, the control unit can be configured to detect an oscillation at the excitation position of the selected excitation element and to determine the control signal for the selected excitation element as a function of the detected oscillation. In particular, the oscillation at the excitation position of the selected excitation element can be detected by the selected excitation element itself. It is possible in this case for the selected excitation element to remain unactuated initially and for the control unit to measure the voltage drops at the excitation element. Especially when the excitation element is an ultrasound transducer comprising a piezoelectric actuator, the voltage drops at the excitation element are essentially proportional to the deflection of the oscillating plate at the excitation position. It is therefore possible to measure the oscillation amplitude, the oscillation frequency, and the oscillation phase at the excitation position of the selected excitation element, and the control signal can be determined in such a way that it compensates for this oscillation. Alternatively, the oscillation can be detected and the selected excitation element can be damped simultaneously. For example, an automatic control circuit can be provided, which keeps the voltage drop at the excitation element essentially at zero and thus also sets the oscillation amplitude at the excitation position of the selected excitation element essentially to zero.

To excite the oscillation of the oscillating plate, it is advantageous for the control unit to provide a control signal at the resonance frequency of the excitation element in question. Thus relatively large oscillation amplitudes can be achieved even with short movements of, for example, a piezoelectric actuator and thus with relatively low control voltages.

Alternatively or in addition to the use of traveling waves to move objects, standing waves of the oscillating plate, i.e., plate eigenforms, can also be used in the oscillating conveyor according to the invention to move objects on the oscillating plate or to suppress the movement of certain objects. Therefore, it is advantageous for the control unit to be able to provide control signals for the excitation elements in such a way that a standing wave is generated on the oscillating plate. A corresponding standing wave or plate eigenform comprises in particular at least one node or at least one nodal line on the oscillating plate at which essentially no oscillation of the oscillating plate is present. In this case, objects move from the antinodes to the nodes. This can be used in particular to separate objects or to accumulate objects in certain areas of the oscillating plate.

The control signals for the excitation elements which lead to the formation of standing waves can be determined in advance by theoretical calculations.

Alternatively, it is possible to determine the desired control signals in a preceding measurement process before the oscillating conveyor is put into use. It is also possible, however, to determine the control signals during the course of the ongoing operation of the oscillating conveyor or during test intervals, such as at the beginning of the use of the oscillating conveyor. Thus it is possible to run through the frequencies of the control signals for one or more excitation elements in a stepwise or continuous manner and, by means of a measurement of the voltages and especially of the currents at the excitation elements or additional sensors, such as optical sensors, it is possible to identify the frequencies which lead to the formation of plate eigenforms.

The objects which are moved by the oscillating conveyor according to the invention can be objects such as electrical components for which specific orientations are desired. It is therefore advantageous for the oscillating conveyor also to comprise an actuator which, when activated by a control unit, causes the entire oscillating plate to oscillate perpendicularly to the conveying surface. A sudden movement of the entire oscillating plate perpendicular to the conveying surface can cause objects to “flip”; that is, it can change the surface of the object by which it rests on the conveying surface.

The additional actuator can be in particular an electromechanical actuator. For example, an electromagnet can be provided underneath or above the oscillating plate, and the oscillating plate itself or an element connecting to the oscillating plate can be magnetic.

By means of the additional actuator, macroscopic movements over a distance of, for example, several millimeters in particular can be initiated. The excitation is pulse-like, but an excitation frequency is typically considerably below the ultrasound range. For example, an excitation cycle of the additional actuator can last for at least 100 μs, especially for at least one millisecond or, for example, 10 milliseconds. Alternatively, it is possible to activate several of the ultrasound transducers synchronously in order to achieve an essentially uniform movement of the entire oscillating plate. The ultrasound transducers typically comprise a relatively short stroke, but very high accelerations at the reversal points of the movement can nevertheless be reached.

To monitor the movement of the objects in the oscillating conveyor according to the invention, it is advantageous to provide sensors which detect the movement and/or the position of the objects. For example, cameras, light barriers, or the like can be provided. It is frequently desirable to install a sensor underneath the oscillating plate or to illuminate the oscillating plate from a position underneath the plate in order to make it especially easy to detect the objects optically by the shadows cast by the light source. It is therefore advantageous for the oscillating plate to be made of a transparent material. The oscillating plate can in particular be made of transparent glass, plastic, or a transparent ceramic. Cubic ZrO₂ or sintered corundum (Al₂O₃) can be used, for example, as a transparent ceramic.

In addition to the oscillating conveyor, the invention also pertains to a method for operating an oscillating conveyor according to the invention, wherein a separate control signal is provided by the control unit for each of the excitation elements, as a result of which the oscillating plate can be caused to execute an overall oscillation by means of which the object present on the conveying surface is moved. In particular, control signals which are not constant are provided to several excitation elements, so that several excited oscillations are superimposed on the oscillating plate. The excitation elements are advantageously activated by control signals of the same frequency.

The control signals of at least two of the excitation elements can be specified in such a way that the distance of the object from the excitation positions of the excitation elements activated in this way is decreased. For example, two excitation elements can be activated, the object being a certain distance away from the line connecting the two elements. The object will move toward the connecting line between the excitation areas of the two excitation elements and thus toward the two excitation positions.

It is possible for at least two objects to be present on the conveying surface, wherein the control signals are previously determined in such a way that the objects are moved so that the distance between the objects is decreased or increased. For a decrease in the distance between the objects, it is possible, for example, to send a non-constant control signal to only one of the excitation elements. In this case, the at least two objects move toward the precisely one excitation position, as a result of which the distance between them can be decreased. If, however, several of the excitation elements are activated to generate oscillations and the objects are located in the area between the excitation positions, the amplitudes of the excitations can be selected in such a way that, for example, at least one of the objects moves toward the first of the excitation elements and at least one other object moves toward a second excitation element.

In the method according to the invention, an oscillating conveyor with at least three excitation elements can be used as the oscillating conveyor, the excitation positions of these elements marking out a quadrilateral on the conveying surface, wherein the control signals sent to each of the individual excitation elements are previously determined in such a way that the object is moved to a predefined position within the quadrilateral. In particular, the excitation elements can mark out a triangle or a quadrilateral. The control signals can in particular be varied in time during while the object is moving toward the specified position.

Supplementally or alternatively, it is possible for the excitation elements to be arranged in such a way that the excitation positions of several of the excitation elements are located along the edges of a polygon. An arrangement of the excitation elements or of their excitation positions along the edges of a quadrilateral makes it possible in particular to achieve an essentially parallel movement of several objects on the oscillating plate, because the several excitation elements arranged along the edge of the quadrilateral are able to produce an essentially flat traveling wave.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows an exemplary embodiment of an oscillating conveyor according to the invention;

FIG. 2 shows a cross-sectional view along line II of the exemplary embodiment shown in FIG. 1;

FIG. 3 shows another exemplary embodiment of an oscillating conveyor according to the invention;

FIG. 4 shows a third exemplary embodiment of an oscillating conveyor according to the invention;

FIG. 5 shows a cross-sectional view of the exemplary embodiment according to FIG. 4 along line V;

FIG. 6 shows a fourth exemplary embodiment of an oscillating conveyor according to the invention; and

FIG. 7 shows a fifth exemplary embodiment of an oscillating conveyor according to the invention.

### DETAILED DESCRIPTION OF THE INVENTION

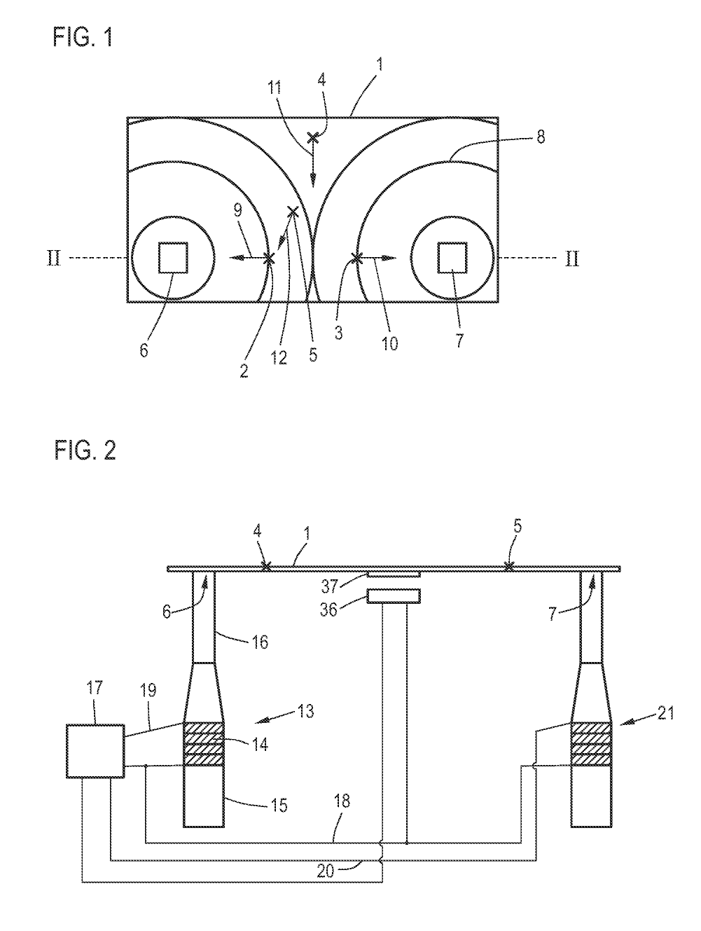

FIGS. 1-7 show numerous exemplary embodiments of oscillating conveyors according to the invention. Exemplary embodiments of the method according to the invention are described in the following as part of the explanations of the exemplary embodiments of the oscillating conveyors according to the invention. An explanation of an exemplary embodiment of a certain method in conjunction with a concrete exemplary embodiment of the oscillating conveyor does not limit the corresponding method to this specific type of oscillating conveyor.

FIG. 1 shows an exemplary embodiment of an oscillating conveyor for the two-dimensional movement of objects. First, on the basis of a plan view of the oscillating plate 1, the movement of the objects 2, 3, 4, and 5 on the oscillating plate 1 under excitation of the oscillating plate 1 at the excitation positions 6 and 7 will be described. The technical implementation of the excitation will be explained later in detail with reference to FIG. 2, which shows a cross section through the oscillating conveyor according to FIG. 1 along line II.

The oscillating plate 1 is excited at the excitation positions 6 and 7 in sinusoidal fashion at the same frequency.

Because the oscillating plate 1 is made of an oscillation-damping material such as a transparent plastic, the excitations cause traveling waves at each position, each wave comprising an amplitude which, starting from the excitation position 6 or 7, decreases with increasing distance. The propagation of these traveling waves is indicated in FIG. 1 by the concentric circles 8.

The distance of the object 2 from the excitation position 6 is considerably shorter than the distance of the object 2 from the excitation position 7. Therefore, the traveling wave traveling from the excitation position 6 to the object 2 has, at the position of the object 2, a much larger amplitude than the traveling wave arriving from excitation position 7. The effect of the traveling wave arriving from excitation position 7 is therefore more-or-less negligible. The object 2 is moved in direction 9 toward the excitation position 6, because an object on an oscillating plate excited by a bending or surface wave always moves in the direction opposite that in which a damped traveling wave propagates. Correspondingly, the object 3 moves in direction 10 toward the excitation position 7. Upon simultaneous excitation of oscillations at the excitation positions 6 and 7 with the same amplitude, therefore, accumulations of objects can be separated, because the objects will be moved in different directions, depending on their position.

The point between the excitation positions 6 and 7 at which the direction of object movement changes can be adjusted by adapting the relative amplitudes of the traveling waves generated at the excitation positions 6 and 7. An oscillating conveyor according to FIG. 1 therefore makes it possible to achieve an easy and flexible separation of objects.

Object 4 is located at exactly the same distance from both excitation positions 6 and 7 but is a certain distance away from a straight line connecting the two excitation positions 6 and 7. By generating traveling waves with the same amplitude at the two excitation positions 6 and 7, the resulting traveling waves are superimposed, so that the oscillating plate 1 is caused to oscillate as a whole. At the object position of the object 4, this overall oscillation corresponds to an incoming traveling wave propagating toward the upper edge of the oscillating plate 1. Correspondingly, the object 4 moves in direction 11, perpendicularly to the line connecting the two excitation positions 6 and 7. By adapting the oscillation amplitudes of the oscillations generated at the excitation positions 6 and 7, the movement direction 11 of the object 4 can be varied. If, for example, excitation is supplied only at the excitation position 6, the object 4 will move toward the excitation position 6. The movement direction 11 of the object 4 can therefore be varied over a wide angular range by adjusting the oscillation amplitudes at the excitation positions 6, 7.

If an object is a certain distance away from a center line between the excitation positions 6 and 7 and also from the connecting line between the excitation positions 6 and 7, as is the case with the object 5, then the resulting overall oscillation at the object position of the object 5 corresponds to a traveling wave proceeding from a point on the connecting line between the excitation positions 6 and 7. Thus the object 5 is moved in direction 12. With increasing proximity to the connecting line between the excitation positions 6 and 7, the movement direction 12 changes in the direction toward the excitation position 6. Under the effect of constant excitation at the excitation positions 6 and 7, the object 5 thus moves along a curved path. The movement direction 12 can also be adjusted at any time by adaptation of the relative excitation amplitudes at the excitation positions 6 and 7, as previously explained on the basis of the object 4.

FIG. 2 shows a cross-sectional view of the oscillating conveyor of FIG. 1 along line II. The excitation of oscillations will be explained first for the excitation position 6. The oscillating plate 1 is coupled to an ultrasound transducer 13 at the excitation position 6. The ultrasound transducer comprises a piezoelectric actuator 14, which is arranged between the oscillating plate 1 and the counterweight 15. The connection of the piezoelectric actuator to the oscillating plate 1 is accomplished by means of a coupling element 16, which is adhered both to the piezoelectric actuator 14 and to the oscillating plate 1. The connection of the coupling element 16 to the piezoelectric actuator 14 and/or to the oscillating plate 1 could, in alternative embodiments, be achieved by means of screwed connections or frictional connections.

The piezoelectric actuator 14 is a multilayer, prestressed piezoelectric actuator, which is arranged in a housing (not shown), which prestresses the piezoelectric crystals of the piezoelectric actuator.

The control unit 17 provides a ground signal via the connection 18 and a control signal for the piezoelectric actuator 14 via the connection 19. As a function of the voltage of the control signal, the piezoelectric actuator 14 expands or contracts. When the control unit transmits an oscillating, especially a sinusoidal, signal, the counterweight 15 oscillates against the oscillating plate 1 as a result of the change in the dimensions of the piezoelectric actuator 14 and thus generates oscillations of the oscillating plate 1 at the excitation position 6.

The control unit 17 also provides a separate control signal for the excitation element 21 via the connection 20, by means of which the oscillating plate 1 can be excited to oscillate at the excitation position 7.

The control unit 17 can adapt the amplitude of the control signal sent to the excitation element 13 independently of the control signal sent to the excitation element 21 in order to control the amplitude ratio of the oscillations generated at the excitation positions 6 and 7. Correspondingly, the control unit 17 can also specify the directions 9, 10, 11, 12 in which the objects 2, 3, 4, 5 move, as explained on the basis of FIG. 1.

In addition, it is possible to adapt the phase position of the control signals for the excitation elements 13, 21 in such a way that the excitation element 13 or the excitation element 21 will operate as a damping element, so that an oscillation of the oscillating plate 1 generated by one of the two excitation elements 13, 21 can be damped by the other one. If, for example, the excitation element 21 is actuated to act as a damper, a traveling wave arriving in the area of the excitation position 7 from the excitation position 6 is damped. The resulting overall oscillation of the oscillating plate 1 thus causes the excitation position 7 to exert a kind of repelling effect on the objects 2, 3, 4, and 5. Additional flexibility is therefore achieved with respect to the determination of the various movement directions 9, 10, 11, 12.

So that the excitation element 21 can act as a damper, it is actuated by a control signal, the phase position of which is permanently fixed with respect to the control signal for the excitation element 13, namely, in such a way that the excitation at the excitation position 7 opposes an oscillation by the traveling wave arriving from the excitation position 6. The phase position of the control signal is acquired from the known speed at which the traveling wave propagates on the oscillating plate 1 and the distance between the excitation positions 6 and 7.

Alternatively, it would be possible to measure this phase position. For this purpose, the excitation element 13 is first actuated by itself with a control signal, and via the connection 20, the control unit 17 measures the voltage drop at the piezoelectric element of the excitation element 21. The phase position for the damping control signal is found from the phase position of the voltage drop relative to the phase position of the control signal for the excitation element 13.

In another alternative embodiment, it would be possible to produce a damping effect in the excitation area 7 by activating the excitation direction 21 by means of the control unit 17 in such a way that the voltage drop at the piezoelectric element is kept at essentially 0 by an automatic control circuit.

For some objects, it is desirable to be able to change the surface by which the object rests on the oscillating plate 1. Such a change in the contact surface is possible in particular by means of a sudden movement of the entire oscillating plate perpendicular to the conveying surface. A perpendicular movement of this type could be achieved by the simultaneous activation of all of the excitation elements 13, 21. To change the contact surface, however, it is typically necessary for the stroke of the oscillating plate to be longer than that which can be achieved by means of the excitation elements 13, 21.

Therefore, an additional actuator 36 is provided, which is configured as an electromagnet. When current is sent to the actuator 36 by the control unit 17, a magnet 37 fastened to the oscillating plate 1 is first attracted by the actuator 36, wherein an elastic bearing (not shown) of the oscillating plate is compressed. This sudden attraction of the permanent magnet 37 leads to a sudden change in the position of the oscillating plate 1, as a result of which the objects briefly leave the conveying surface as a result of their inertia.

When the current to the actuator 36 is cut off by the control unit 17, the oscillating plate 1 “snaps back”, and the objects are suddenly and strongly shaken in the direction perpendicular to the conveying surface, as a result of which the contact surface can be changed.

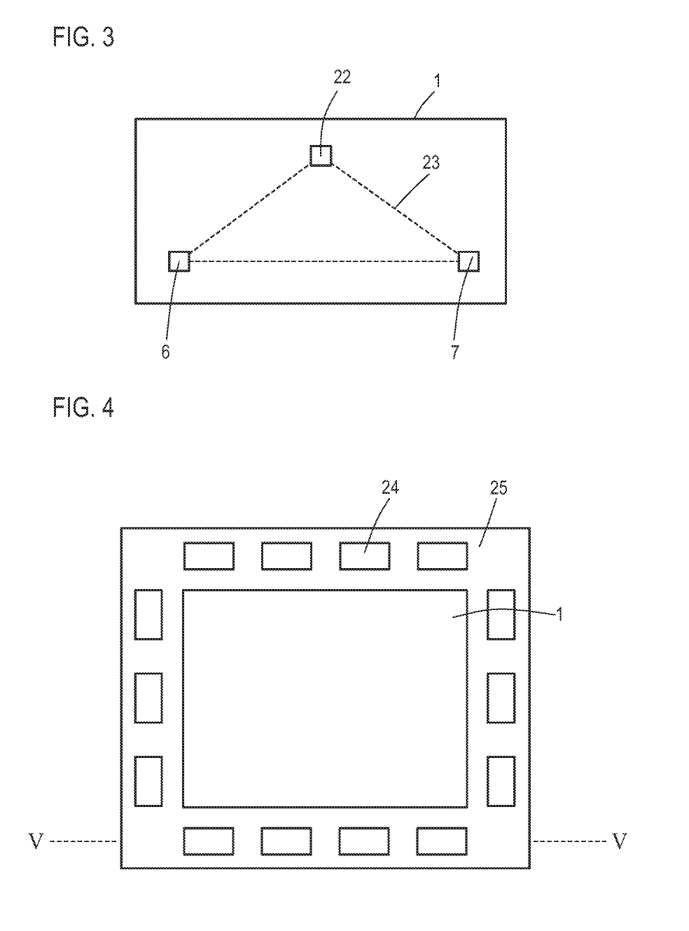

In an oscillating conveyor according to FIG. 3, the excitation elements 13, 21 at excitation positions 6, 7 are supplemented by an additional excitation element, which can cause the oscillating plate 1 to oscillate at the excitation position 22 as a function of a separate control signal. By supplying appropriate control signals, the provision of the additional excitation position 22 also makes it possible to move an object resting on the oscillating plate 1 in the direction toward the excitation position 22, in the direction toward the line connecting the excitation position 22 and the excitation position 6, or in the direction toward the line connecting the excitation position 22 and the excitation position 7. An object which is resting on the conveying surface of the oscillating plate can thus be moved to any position in the triangle 23 indicated by the broken line.

FIG. 4 shows another exemplary embodiment of an oscillating conveyor for two-dimensional movement of objects on the conveying surface of the oscillating plate 1. The oscillating plate 1 here is rectangular, wherein several excitation areas 24 with their associated excitation elements are provided along each side of the rectangle. A damper element 25, furthermore, namely, a layer consisting of an elastic material with high internal friction such as rubber, is adhered to the areas of the conveying surface near the edge and to the areas of the side of the oscillating plate 1 facing away from the conveying surface near the edge.

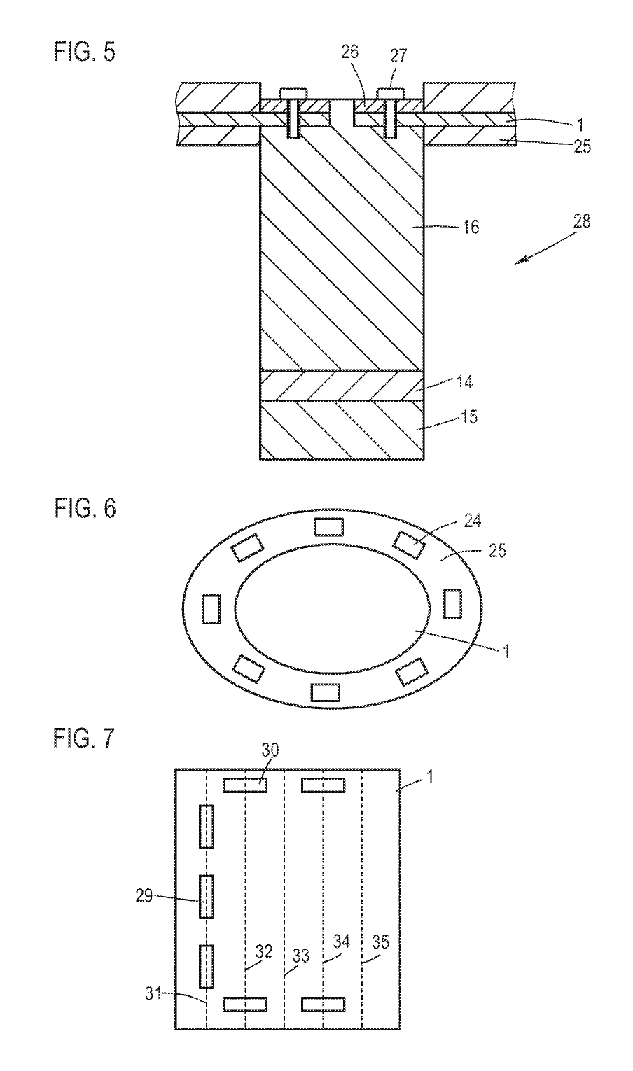

FIG. 5 shows a cross-sectional view of the oscillating conveyor of FIG. 4 along the line V. The excitation element 28, which is coupled to the oscillating plate 1 at the excitation position 24, comprises a counterweight 15, a piezoelectric actuator 14, and a coupling element 16. The structure and function of the excitation element 28 are the same as those of the excitation element 13 explained in conjunction with FIG. 2.

The coupling element 16 passes through the central part of the excitation area 24 of the oscillating plate 1 and is screwed laterally of this central area to the oscillating plate 1 by way of a spacer plate 26 and screws 27. Because the coupling element passes through the oscillating plate 1, the excitation element 28 is stabilized against lateral movements parallel to the conveying surface. Because the components are screwed together and because of the additional support provided by the spacer plate 26, the oscillations are transmitted very effectively from the excitation element 28 into the oscillating plate 1.

The use of the damper element 25 serves two functions. The effect of damping the edges of the oscillating plate 1 is to suppress reflections at the edge of the oscillating plate 1 almost completely, as a result of which the formation of standing waves on the oscillating plate 1 is avoided. Whereas, as will be explained in the following on the basis of FIG. 7, standing waves or plate eigenforms can be used advantageously in oscillating conveyors, the suppression of these standing waves makes it possible to actuate the excitation elements 28 of the oscillating conveyor in an especially simple way.

By means of the damping element 25 and the use of several relatively closely-spaced excitation positions along the edges of the oscillating plate 1, furthermore, an essentially flat traveling wave is generated when the excitation elements 28 assigned to the excitation positions 24 along one side of the oscillating plate 1 are actuated in the same way. This traveling wave propagates from one side of the oscillating plate 1 toward the other side of the oscillating plate 1. This has the effect of moving objects on the conveying surface of the oscillating plate 1—in particular independently of their positions—in the same direction and parallel to each other. The use of several excitation positions along one side of an oscillating plate in conjunction with edge damping of the oscillating plate 1 thus makes possible an essentially position-independent determination of the movement direction for one or more objects on the conveying surface of the oscillating plate 1. When the excitation elements 28 assigned to the excitation areas 24 are actuated in other ways, it is also possible, in the case of the oscillating conveyor shown in FIGS. 4 and 5, to determine the direction of movement in a manner which depends on the position of the object, so that objects can also be separated. In the simplest case, the excitation elements 28 arranged on two opposite edges of the oscillating plate 1 can be activated to provide an essentially flat traveling wave proceeding from each edge. Depending on the position of the objects on the conveying surface and the relative excitation amplitudes, the objects are thus moved toward the one or the other edge of the oscillating plate 1.

FIG. 6 shows another exemplary embodiment of an oscillating conveyor. The form of the oscillating plate 1 is oval, and the excitation elements 24 are arranged at the edge, around the periphery of the oscillating plate 1. Otherwise, the oscillating conveyor shown in FIG. 6 corresponds with respect to structure and function to the conveyor shown in FIGS. 4 and 5.

FIG. 7 shows a fifth exemplary embodiment of an oscillating conveyor, in which plate eigenforms are used to move objects. For this purpose, a control unit sends control signals to the three excitation elements assigned to the excitation positions 29, these signals being at a frequency which corresponds to a resonance frequency of a bending oscillation of the oscillating plate 1 in the transverse direction of FIG. 7. As a result of the synchronous coupling of the oscillations into the excitation areas 29, an essentially flat wave first propagates transversely from the excitation areas 29 . The upper and lower edges of the oscillating plate 1 in FIG. 7 can be additionally damped by damping elements (not shown) in order to suppress reflections.

If the flat wave is only slightly damped by the oscillating plate 1, it is reflected from the edges of the oscillating plate 1 at the left and right in the figure. By a superimposition of the oscillating excitation at the excitation positions 29 and the reflected waves, a standing wave is formed, which comprises the antinodes in the areas indicated by the lines 31, 33, and 35 and the nodes of the wave in the areas indicated by the lines 32 and 34, that is, the areas in which no oscillation of the oscillating plate 1 occurs as a result of the excitation at the excitation positions 29.

If no oscillation of the oscillating plate 1 is excited at the excitation positions 30, then this leads to a movement of the objects to the lines 32, 34. If, as explained on the basis of the preceding exemplary embodiments, an excitation now occurs at the excitation positions 30 at a frequency which does not correspond to any resonance frequency of the oscillating plate 1, especially if it now occurs at a resonance frequency of one of the excitation elements assigned to the excitation position in question, then, in particular, the objects can be moved upward in FIG. 7. A movement in the transverse direction is at least partially suppressed by the stabilization of the objects in the areas of the nodal lines 32, 34, so that, for example, an upward movement of the objects in the area of line 32 and a downward movement of the objects in the area of the line 34 are possible, wherein a movement of the objects between the areas of the lines 32 and 34 is suppressed by the antinode of the standing wave in the area of the line 33.

While specific embodiments of the invention have been shown and described in detail to illustrate the inventive principles, it will be understood that the invention may be embodied otherwise without departing from such principles.

We claim:

1. An oscillating conveyor for the two-dimensional movement of objects, comprising an oscillating plate, on the conveying surface of which at least one object is movable by the oscillations of the oscillating plate, and at least two excitation elements for exciting oscillations in the oscillating plate, wherein the excitation elements are ultrasound transducers coupled to the oscillating plate at excitation positions spaced a certain distance apart, by means of which transducers the oscillating plate can be excited to oscillate at the excitation position in question as a function of a control signal, which can be sent individually by a control unit to each excitation element.

2. An oscillating conveyor according to claim 1, wherein the excitation elements can be actuated by the control unit in such a way that the conveying surface can be caused to execute an overall oscillation by the superimposition of the excited oscillations.

3. An oscillating conveyor according to claim 1, wherein it comprises at least three excitation elements, wherein the excitation position of the third excitation element is a certain distance away from a straight line connecting the excitation positions of the first and second excitation elements.

4. An oscillating conveyor according to claim 1, wherein the oscillating plate is polygonal, especially quadrilateral, with several sides, wherein at least one of the excitation elements is arranged at the edge in the area of each side.

5. An oscillating conveyor according to claim 1, wherein the oscillating plate is essentially round or elliptical, wherein the excitation elements are arranged at the edge around the periphery.

6. An oscillating conveyor according to claim 1, wherein each of the ultrasound transducers comprises a multilayer, in particular a prestressed, piezoelectric actuator.

7. An oscillating conveyor according to claim 6, wherein each of the piezoelectric actuators is arranged between the oscillating plate and a counterweight.

8. An oscillating conveyor according to claim 6, wherein each of the piezoelectric actuators or each of the coupling elements permanently connected to the piezoelectric actuator is adhered and/or screwed and/or positively fitted to the oscillating plate.

9. An oscillating conveyor according to claim 1, wherein the oscillating conveyor comprises at least one damping element, and/or the oscillating plate itself is formed out of an oscillation-damping material, so that the oscillation amplitude of the oscillating plate, upon excitation by at least one of the excitation elements, decreases in at least one direction along the conveying surface with increasing distance from the excitation position assigned to the excitation element.

10. An oscillating conveyor according to claim 9, wherein the damping element is arranged on a lateral surface and/or on the conveying surface near the edge and/or on the surface of the oscillating plate facing away from the conveying surface, near the edge.

11. An oscillating conveyor according to claim 9, wherein the damping element is a flat layer consisting of oscillation-damping material.

12. An oscillating conveyor according to claim 1, wherein at least one selected excitation element can be controlled by the control unit in such a way that an oscillation amplitude of an oscillation of the oscillating plate generated by at least one of the other excitation elements is reduced at the excitation position assigned to the selected excitation element.

13. An oscillating conveyor according to claim 12, wherein the control unit is configured to actuate the selected excitation element by means of a control signal which is phase-locked in a previously determined phase position to the control signal of the other excitation element.

14. An oscillating conveyor according to claim 12, wherein the control unit is configured to detect an oscillation at the excitation position of the selected excitation element and to determine the control signal for the selected excitation element as a function of the detected oscillation.

15. An oscillating conveyor according to claim 1, wherein the control unit can provide a control signal at the resonance frequency of the individual excitation element in question.

16. An oscillating conveyor according to claim 1, wherein the control unit can provide control signals for the excitation elements in such a way that a standing wave is generated on the oscillating plate.

17. An oscillating conveyor according to claim 1, wherein it also comprises an actuator, upon the activation of which by the control unit, the entire oscillating plate is moved perpendicularly to the conveying surface.

18. An oscillating conveyor according to claim 1, wherein the oscillating plate is made out of a transparent material.

19. A method for operating an oscillating conveyor according to claim 1, wherein the control unit provides a separate control signal for each of the excitation elements, as a result of which the oscillating plate is caused to execute an overall oscillation which causes the object resting on the conveying surface to move.

20. A method according to claim 19, wherein the control signals for at least two of the excitation elements are determined in such a way that the distance of the object from the excitation positions of the excitation elements thus actuated is decreased.

21. A method according to claim 19, wherein at least two objects are present on the conveying surface, wherein the control signals are determined so that the objects are moved in such a way that the distance between the objects is decreased or increased.

22. A method according to claim 19, wherein, as the oscillating conveyor, an oscillating conveyor with at least three excitation elements is used, the excitation positions of which mark out a polygon on the conveying surface, wherein the control signal sent to each of the excitation elements is determined in such a way that the first object is moved to a previously determined position inside the polygon.
